(19) United States
(12) Patent Application Publication
(10) Pub. No.: US 2024/0005358 A1
(43) Pub. Date: Jan. 4, 2024

(54) METHOD AND SYSTEM FOR FACILITATING PREDICTIVE ANALYTICS BY LEVERAGING GEOLOCATION DATA

(71) Applicant: JPMorgan Chase Bank, N.A., New York, NY (US)

(72) Inventor: Varun BHAGWAN, Los Gatos, CA (US)

(73) Assignee: JPMorgan Chase Bank, N.A., New York, NY (US)

(21) Appl. No.: 17/810,063

(22) Filed: Jun. 30, 2022

(51) Int. Cl. G06Q 30/02; G06N 5/02

(52) U.S. Cl. CPC G06Q 30/0261; G06N 5/022

(57) ABSTRACT

A method for facilitating predictive analytics based on geographic information from targeted advertising is disclosed. The method includes generating advertisement campaigns for clients based on a corresponding identity graph; associating a tag with the generated advertisement campaigns, the tag corresponding to instructions to collect location data when the advertisement campaigns are rendered on a client device; distributing, by using the identity graph, the advertisement campaigns together with the tag to the corresponding clients; receiving the location data for each of the clients when the advertisement campaigns are rendered; determining a geographic location profile for each of the clients based on the received location data; and developing a predictive model by using the geographic location profile.

### BACKGROUND

### 1. Field of the Disclosure

This technology generally relates to methods and systems for facilitating predictive analytics, and more particularly to methods and systems for facilitating predictive analytics via machine learning models based on geographic information from targeted advertising.

### 2. Background Information

Many business entities utilize predictive analytics to identify intents such as, for example, expansion intents, strategic options intents, and fund-raising intents of existing and potential clients. Often, the predictive analytics are implemented via algorithmic or machine learning models that leverage available business data. Historically, implementations of conventional techniques to facilitate the predictive analytics have resulted in varying degrees of success with respect to predictive accuracy and timeliness.

One drawback of using the conventional techniques is that in many instances, the available business data are limited to information such as, for example, account information that is collected during ordinary course of business. As such, the conventional techniques do not sufficiently provide timely and accurate predictions because the available business data may not reflect targeted groups such as, for example, groups who do not interact with the business entities during the ordinary course of business. Additionally, conventional predictive analytic techniques rely on manual data interpretation, which is susceptible to biases.

Therefore, there is a need for a system that utilizes machine learning models to facilitate predictive analytics based on geographic information that is obtained from targeted advertising of specific individuals.

### SUMMARY

The present disclosure, through one or more of its various aspects, embodiments, and/or specific features or sub-components, provides, inter alia, various systems, servers, devices, methods, media, programs, and platforms for facilitating predictive analytics via machine learning models based on geographic information from targeted advertising.

According to an aspect of the present disclosure, a method for facilitating predictive analytics based on geographic information from targeted advertising is disclosed. The method is implemented by at least one processor. The method may include generating at least one advertisement campaign for at least one client based on a corresponding identity graph; associating at least one tag with the generated at least one advertisement campaign, the at least one tag may correspond to instructions to collect location data when the at least one advertisement campaign is rendered on a client device; distributing, by using the identity graph, the at least one advertisement campaign together with the at least one tag to the corresponding at least one client; receiving the location data for each of the at least one client when the at least one advertisement campaign is rendered; determining a geographic location profile for each of the at least one client based on the received location data; and developing at least one predictive model by using the geographic location profile.

In accordance with an exemplary embodiment, the method may further include determining, by using the at least one predictive model, at least one client intent for each of the at least one client, the at least one client intent may relate to a predicted operating strategy; and assigning, by using the at least one predictive model, a confidence score for each of the at least one client intent.

In accordance with an exemplary embodiment, prior to generating the at least one advertisement campaign, the method may further include aggregating raw data from at least one source, the raw data may include identity information for the at least one client; and generating the identity graph for each of the at least one client based on the raw data.

In accordance with an exemplary embodiment, the identity information may include at least one from among a name, an email address, a phone number, and a device identifier that is associated with the at least one client.

In accordance with an exemplary embodiment, the method may further include aggregating outcome data that corresponds to each of the at least one client; and training the at least one predictive model by using the outcome data.

In accordance with an exemplary embodiment, the outcome data may relate to historical business activity data that corresponds to each of the at least one client, the historical business activity data may include at least one from among merger data, acquisition data, and branch location data.

In accordance with an exemplary embodiment, the at least one client may relate to an advertising target that corresponds to at least one from among an existing client and a potential client, the at least one client may include at least one decision maker that is associated with an external entity.

In accordance with an exemplary embodiment, the geographic location profile for each of the at least one client may be dynamically updated with new location data, the new location data may result from subsequent renders of the at least one advertisement campaign.

In accordance with an exemplary embodiment, the at least one predictive model may include at least one from among a machine learning model, a mathematical model, a process model, and a data model.

According to an aspect of the present disclosure, a computing device configured to implement an execution of a method for facilitating predictive analytics based on geographic information from targeted advertising is disclosed. The computing device including a processor; a memory; and a communication interface coupled to each of the processor and the memory, wherein the processor may be configured to generate at least one advertisement campaign for at least one client based on a corresponding identity graph; associate at least one tag with the generated at least one advertisement campaign, the at least one tag may correspond to instructions to collect location data when the at least one advertisement campaign is rendered on a client device; distribute, by using the identity graph, the at least one advertisement campaign together with the at least one tag to the corresponding at least one client; receive the location data for each of the at least one client when the at least one advertisement campaign is rendered; determine a geographic location profile for each of the at least one client based on the received location data; and develop at least one predictive model by using the geographic location profile.

In accordance with an exemplary embodiment, the processor may be further configured to determine, by using the at least one predictive model, at least one client intent for each of the at least one client, the at least one client intent may relate to a predicted operating strategy; and assign, by using the at least one predictive model, a confidence score for each of the at least one client intent.

In accordance with an exemplary embodiment, prior to generating the at least one advertisement campaign, the processor may be further configured to aggregate raw data from at least one source, the raw data may include identity information for the at least one client; and generate the identity graph for each of the at least one client based on the raw data.

In accordance with an exemplary embodiment, the identity information may include at least one from among a name, an email address, a phone number, and a device identifier that is associated with the at least one client.

In accordance with an exemplary embodiment, the processor may be further configured to aggregate outcome data that corresponds to each of the at least one client; and train the at least one predictive model by using the outcome data.

In accordance with an exemplary embodiment, the outcome data may relate to historical business activity data that corresponds to each of the at least one client, the historical business activity data may include at least one from among merger data, acquisition data, and branch location data.

In accordance with an exemplary embodiment, the at least one client may relate to an advertising target that corresponds to at least one from among an existing client and a potential client, the at least one client may include at least one decision maker that is associated with an external entity.

In accordance with an exemplary embodiment, the processor may be further configured to dynamically update the geographic location profile for each of the at least one client with new location data, the new location data may result from subsequent renders of the at least one advertisement campaign.

In accordance with an exemplary embodiment, the at least one predictive model may include at least one from among a machine learning model, a mathematical model, a process model, and a data model.

According to an aspect of the present disclosure, a non-transitory computer readable storage medium storing instructions for facilitating predictive analytics based on geographic information from targeted advertising is disclosed. The storage medium including executable code which, when executed by a processor, may cause the processor to generate at least one advertisement campaign for at least one client based on a corresponding identity graph; associate at least one tag with the generated at least one advertisement campaign, the at least one tag may correspond to instructions to collect location data when the at least one advertisement campaign is rendered on a client device; distribute, by using the identity graph, the at least one advertisement campaign together with the at least one tag to the corresponding at least one client; receive the location data for each of the at least one client when the at least one advertisement campaign is rendered; determine a geographic location profile for each of the at least one client based on the received location data; and develop at least one predictive model by using the geographic location profile.

In accordance with an exemplary embodiment, the executable code, when executed by the processor, may further cause the processor to determine, by using the at least one predictive model, at least one client intent for each of the at least one client, the at least one client intent may relate to a predicted operating strategy; and assign, by using the at least one predictive model, a confidence score for each of the at least one client intent.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for facilitating predictive analytics via machine learning models based on geographic information from targeted advertising.

FIG. 4 is a flowchart of an exemplary process for implementing a method for facilitating predictive analytics via machine learning models based on geographic information from targeted advertising.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

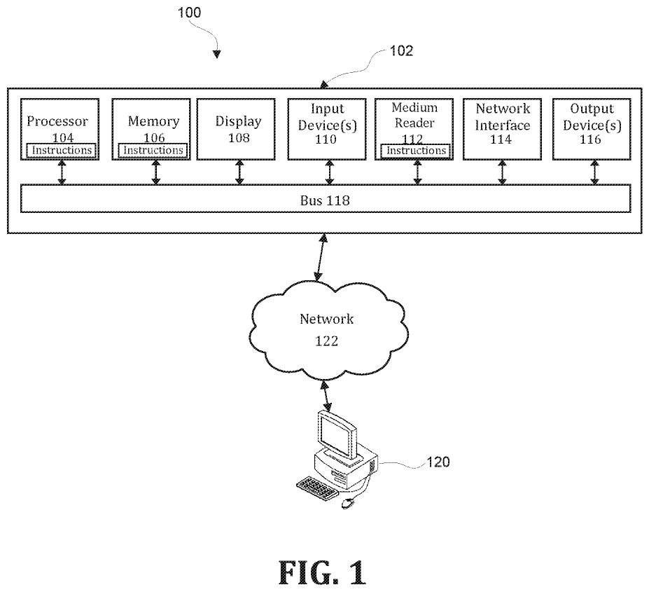

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for facilitating predictive analytics via machine learning models based on geographic information from targeted advertising.

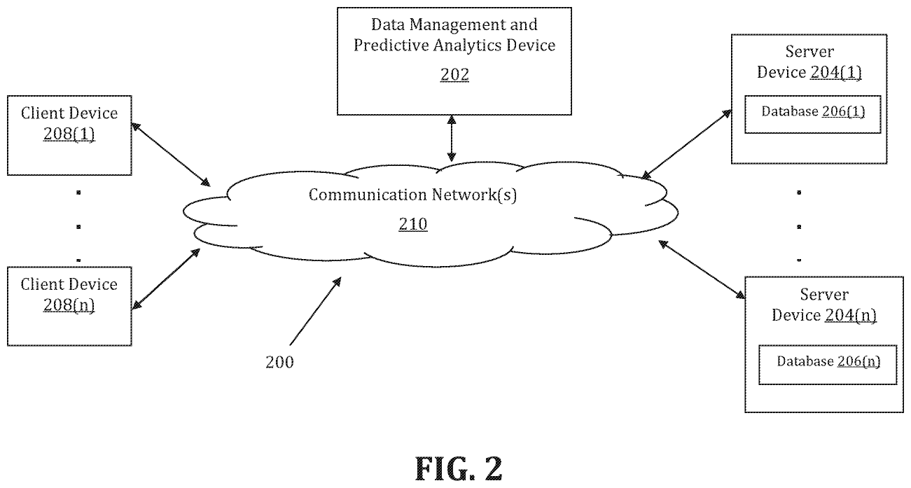

Referring to FIG. 2, a schematic of an exemplary network environment 200 for implementing a method for facilitating predictive analytics via machine learning models based on geographic information from targeted advertising is illustrated. In an exemplary embodiment, the method is executable on any networked computer platform, such as, for example, a personal computer (PC).

The method for facilitating predictive analytics via machine learning models based on geographic information from targeted advertising may be implemented by a Data Management and Predictive Analytics (DMPA) device 202. The DMPA device 202 may be the same or similar to the computer system 102 as described with respect to FIG. 1. The DMPA device 202 may store one or more applications that can include executable instructions that, when executed by the DMPA device 202, cause the DMPA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DMPA device 202 itself, may be located in virtual server(s) running in a cloud-based computing environment rather than being tied to one or more specific physical network computing devices. Also, the application(s) may be running in one or more virtual machines (VMs) executing on the DMPA device 202. Additionally, in one or more embodiments of this technology, virtual machine(s) running on the DMPA device 202 may be managed or supervised by a hypervisor.

In the network environment 200 of FIG. 2, the DMPA device 202 is coupled to a plurality of server devices 204(1)-204(n) that hosts a plurality of databases 206(1)-206(n), and also to a plurality of client devices 208(1)-208(n) via communication network(s) 210. A communication interface of the DMPA device 202, such as the network interface 114 of the computer system 102 of FIG. 1, operatively couples and communicates between the DMPA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DMPA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and DMPA devices that efficiently implement a method for facilitating predictive analytics via machine learning models based on geographic information from targeted advertising.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DMPA device 202 may be a standalone device or integrated with one or more other devices or apparatuses, such as one or more of the server devices 204(1)-204(n), for example. In one particular example, the DMPA device 202 may include or be hosted by one of the server devices 204(1)-204(n), and other arrangements are also possible. Moreover, one or more of the devices of the DMPA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DMPA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to advertisement campaigns, identity graphs, tags, location data, geographic location profiles, predictive models, machine learning models, client intents, and confidence scores.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the DMPA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the DMPA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the DMPA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DMPA device 202, the server devices 204(1)-204(n), or the client devices 208(1)-208(n), for example, may be configured to operate as virtual instances on the same physical machine. In other words, one or more of the DMPA device 202, the server devices 204(1)-204(n), or the client devices 208(1)-208(n) may operate on the same physical device rather than as separate devices communicating through communication network(s) 210. Additionally, there may be more or fewer DMPA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

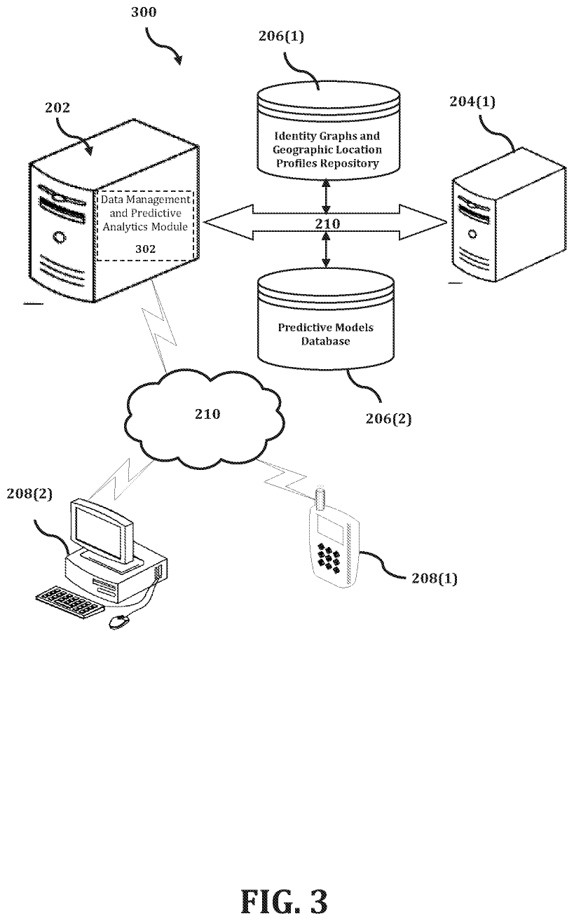

The DMPA device 202 is described and shown in FIG. 3 as including a data management and predictive analytics module 302, although it may include other rules, policies, modules, databases, or applications, for example. As will be described below, the data management and predictive analytics module 302 is configured to implement a method for facilitating predictive analytics via machine learning models based on geographic information from targeted advertising.

An exemplary process 300 for implementing a mechanism for facilitating predictive analytics via machine learning models based on geographic information from targeted advertising by utilizing the network environment of FIG. 2 is shown as being executed in FIG. 3. Specifically, a first client device 208(1) and a second client device 208(2) are illustrated as being in communication with DMPA device 202. In this regard, the first client device 208(1) and the second client device 208(2) may be “clients” of the DMPA device 202 and are described herein as such. Nevertheless, it is to be known and understood that the first client device 208(1) and/or the second client device 208(2) need not necessarily be “clients” of the DMPA device 202, or any entity described in association therewith herein. Any additional or alternative relationship may exist between either or both of the first client device 208(1) and the second client device 208(2) and the DMPA device 202, or no relationship may exist.

Further, DMPA device 202 is illustrated as being able to access an identity graphs and geographic location profiles repository 206(1) and a predictive models database 206(2). The data management and predictive analytics module 302 may be configured to access these databases for implementing a method for facilitating predictive analytics via machine learning models based on geographic information from targeted advertising.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the DMPA device 202 via broadband or cellular communication. Of course, these embodiments are merely exemplary and are not limiting or exhaustive.

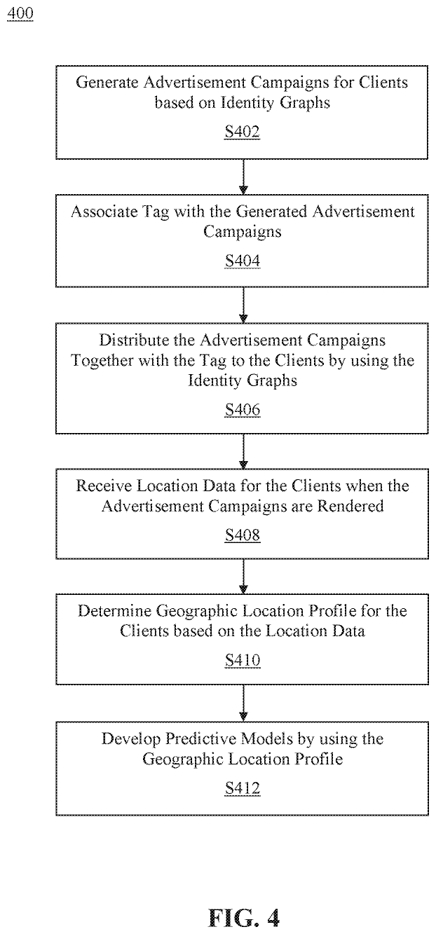

Upon being started, the data management and predictive analytics module 302 executes a process for facilitating predictive analytics via machine learning models based on geographic information from targeted advertising. An exemplary process for facilitating predictive analytics via machine learning models based on geographic information from targeted advertising is generally indicated at flowchart 400 in FIG. 4.

In the process 400 of FIG. 4, at step S402, an advertisement campaign for a client may be generated based on a corresponding identity graph. In an exemplary embodiment, the advertisement campaign may relate to a series of advertisement messages that share a single idea and theme. The advertisement campaign may designate a particular time frame and utilize diverse media channels such as, for example, electronic advertising via a mobile application.

In another exemplary embodiment, the advertisement campaign may relate to an existing advertisement campaign associated with the client as well as a newly generated advertisement campaign based on the corresponding identity graph. For example, the identity graph may indicate that the client is currently associated with an ongoing advertisement campaign that may be usable consistent with present disclosures.

In another exemplary embodiment, the theme may relate to a central message that will be received in the promotional activities and may be the prime focus of the advertisement campaign. The theme may set a motif for the series of individual advertisements and other marketing communications that will be used. In another exemplary embodiment, the theme may be selected based on information in the identity graph to target a corresponding client. For example, a car advertisement theme may be selected based on a client interest in cars.

In another exemplary embodiment, raw data may be aggregated from sources prior to generating the advertisement campaign. The raw data may include identity information for the client. In another exemplary embodiment, the raw data may include unstructured data. The unstructured data may be parsed, mapped, and processed into a structured data set during aggregation consistent with present disclosures. In another exemplary embodiment, the identity information may relate to personally identifiable information that is associated with the client. The identity information may include at least one from among a name, an email address, a phone number, and a device identifier that is associated with the client.

In another exemplary embodiment, the sources may include at least one from among an external data source and an internal data source. The external data source may correspond to a third-party data source such as, for example, a data vendor and the internal data source may correspond to a first-party data source such as, for example, an internal account management system. Then, the identity graph may be generated for the client based on the raw data.

In another exemplary embodiment, the client may relate to an advertising target that corresponds to at least one from among an existing client and a potential client. The client may include at least one decision maker that is associated with an external entity. In another exemplary embodiment, the client may correspond to an individual decision maker. For example, the client may include an executive such as a chief executive officer (CEO), a chief operating officer (COO), and a chief technology officer (CTO) of a company. In another exemplary embodiment, the client may correspond to a group of individuals with roles within the decision-making process. For example, the client may include associated realtors tasked with finding suitable locations for a new warehouse.

In another exemplary embodiment, the identity graph may correspond to the client. The identity graph may provide a single unified view of the client based on client interactions across client devices and client identifiers. In another exemplary embodiment, the identity graph may be usable for real-time personalization and advertisement targeting for the client. The identity graph may link multiple types of client identifiers to form a consistent, unified view of the client. The identity graph may persist profile data for the client to facilitate connection of new client identifiers to existing client profiles.

At step S404, a tag may be associated with the generated advertisement campaign. In an exemplary embodiment, the tag may correspond to instructions that are appended to a software program in a markup language in order to specify an operating characteristic. The tag may include a set of instructions to collect location data when the advertisement campaign is rendered on a client device. For example, the tag may be appended to the advertisement campaign such that there is a geographic location determination whenever an advertisement associated with the advertisement campaign is rendered for the client on the client device.

In another exemplary embodiment, the location data may relate to geospatial information about a specific geographical location. The geospatial information may correspond to the specific geographical location of the client device. In another exemplary embodiment, the location data may be determined via a navigation system such as, for example, a global positioning system (GPS) in the client device. The navigation system may provide the location of the client device as geographic coordinates such as, for example, a latitude and a longitude.

At step S406, the advertisement campaign may be distributed together with the tag. The advertisement campaign and the tag may be distributed to the client by using client information in the identity graph. In an exemplary embodiment, the advertisement campaign may be automatically distributed to the client according to a predetermined guideline such as, for example, a business guideline and a regulatory guideline. For example, the business guideline may dictate a frequency and a number of advertisements for a particular client.

At step S408, the location data for the client may be received when the advertisement campaign is rendered. In an exemplary embodiment, the location data may be received via the client device according to the tag consistent with disclosures in the present application. The received location data may include identifying information to facilitate association of a location with the client. In another exemplary embodiment, the location data may be received each time the advertisement campaign is rendered and as a batch based on a predetermined location data reporting schedule. For example, the location data reporting schedule may dictate that all daily location data for the client is combined into a batch file for daily transmission.

At step S410, a geographic location profile may be determined for the client based on the received location data. In an exemplary embodiment, the geographic location profile may relate to a representation such as, for example, a graphical representation of information that relates to a location characteristic of the client. The location characteristic of the client may be recorded in quantified form.

In another exemplary embodiment, the location characteristic may relate to a correlation between a plurality of clients. The correlation may visually represent a mutual relationship and/or connection between the plurality of clients. For example, location characteristics of executives from company A and company B may indicate a geographic proximity that suggests a relationship between company A and company B. In another example, location characteristics of an executive from company C and a realtor may indicate a geographic proximity that suggests an intention by company C to purchase real estate assets.

In another exemplary embodiment, the geographic location profile for the client may be dynamically updated with new location data consistent with present disclosures. The new location data may result from subsequent renders of the advertisement campaign. Consistent with present disclosures, the geographic location profile may be determined and updated by using a data model to facilitate predictive analytics.

At step S412, a predictive model may be developed by using the geographic location profile. In an exemplary embodiment, a client intent may be determined by using the predictive model. The client intent may relate to a predicted operating strategy of the client as well as the entity associated with the client. For example, the client intent may indicate that the entity is likely to expand with additional branches when the geographic location profile shows the client within proximity of a realtor. Likewise, the client intent may indicate a possible strategic option and/or a capital fundraising when the geographic location profile shows the client within proximity of another client or a venture capitalist.

In another exemplary embodiment, a confidence score may be assigned to the determined client intent by using the predictive model. The confidence score may represent a likelihood of a predicted event occurring. For example, a higher confidence score may indicate that predicted event A is more likely to occur than predicted event B, which has a lower confidence score. As will be appreciated by a person of ordinary skill in the art, the confidence score may relate to any measurement of confidence in a prediction such as, for example, a confidence level.

In another exemplary embodiment, the predictive model may include at least one from among a machine learning model, a mathematical model, a process model, and a data model. The model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

In another exemplary embodiment, outcome data that corresponds to the client may be aggregated. The outcome data may relate to historical business activity data that corresponds to the client. The historical business activity data may include at least one from among merger data, acquisition data, and branch location data. Then, the predictive model may be trained by using the outcome data. In another exemplary embodiment, training the predictive model may include a comparison between a predicted client intent and actual outcome based on business activity data. As will be appreciated by a person of ordinary skill in the art, training the predictive model with actual outcome data may increase predictive accuracy of the predictive model.

Accordingly, with this technology, an optimized process for facilitating predictive analytics via machine learning models based on geographic information from targeted advertising is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method for facilitating predictive analytics based on geographic information from targeted advertising, the method being implemented by at least one processor, the method comprising:
generating, by the at least one processor, at least one advertisement campaign for at least one client based on a corresponding identity graph;
associating, by the at least one processor, at least one tag with the generated at least one advertisement campaign, the at least one tag corresponding to instructions to collect location data when the at least one advertisement campaign is rendered on a client device;
distributing, by the at least one processor using the identity graph, the at least one advertisement campaign together with the at least one tag to the corresponding at least one client;
receiving, by the at least one processor, the location data for each of the at least one client when the at least one advertisement campaign is rendered;
determining, by the at least one processor, a geographic location profile for each of the at least one client based on the received location data by,
determining, by the at least one processor, a location characteristic for each of the at least one client based on a geographic proximity between the corresponding at least one client and at least one other client,
wherein the location characteristic indicates a mutual connection between the corresponding at least one client and the at least one other client;
wherein the location characteristic for each of the at least one client is numerically represented in quantified form;
wherein the location characteristic for each of the at least one client is recorded in the quantified form; and
wherein the geographic location profile includes the location characteristic;
developing, by the at least one processor, at least one predictive model by using the geographic location profile; and
assessing, by the at least one processor, the at least one predictive model to determine whether at least one rate is within a predetermined range.

2. The method of claim 1, further comprising:
determining, by the at least one processor using the at least one predictive model, at least one client intent for each of the at least one client, the at least one client intent relating to a predicted operating strategy; and
assigning, by the at least one processor using the at least one predictive model, a confidence score for each of the at least one client intent.

3. The method of claim 1, wherein prior to generating the at least one advertisement campaign, the method further comprises:
aggregating, by the at least one processor, raw data from at least one source, the raw data including identity information for the at least one client; and
generating, by the at least one processor, the identity graph for each of the at least one client based on the raw data.

4. The method of claim 3, wherein the identity information includes at least one from among a name, an email address, a phone number, and a device identifier that is associated with the at least one client.

5. The method of claim 1, further comprising:
aggregating, by the at least one processor, outcome data that corresponds to each of the at least one client; and
training, by the at least one processor, the at least one predictive model by using the outcome data.

6. The method of claim 5, wherein the outcome data relates to historical business activity data that corresponds to each of the at least one client, the historical business activity data including at least one from among merger data, acquisition data, and branch location data.

7. The method of claim 1, wherein the at least one client relates to an advertising target that corresponds to at least one from among an existing client and a potential client, the at least one client including at least one decision maker that is associated with an external entity.

8. The method of claim 1, wherein the geographic location profile for each of the at least one client is dynamically updated with new location data, the new location data resulting from subsequent renders of the at least one advertisement campaign.

9. The method of claim 1, wherein the at least one predictive model includes at least one from among a machine learning model, a mathematical model, a process model, and a data model.

10. A computing device configured to implement an execution of a method for facilitating predictive analytics based on geographic information from targeted advertising, the computing device comprising:
a processor;
a memory; and
a communication interface coupled to each of the processor and the memory,
wherein the processor is configured to:
generate at least one advertisement campaign for at least one client based on a corresponding identity graph;
associate at least one tag with the generated at least one advertisement campaign, the at least one tag corresponding to instructions to collect location data when the at least one advertisement campaign is rendered on a client device;
distribute, by using the identity graph, the at least one advertisement campaign together with the at least one tag to the corresponding at least one client;
receive the location data for each of the at least one client when the at least one advertisement campaign is rendered;
determine a geographic location profile for each of the at least one client based on the received location data by causing the processor to:
determine a location characteristic for each of the at least one client based on a geographic proximity between the corresponding at least one client and at least one other client,
wherein the location characteristic indicates a mutual connection between the corresponding at least one client and the at least one other client;
wherein the location characteristic for each of the at least one client is numerically represented in quantified form;
wherein the location characteristic for each of the at least one client is recorded in the quantified form; and
wherein the geographic location profile includes the location characteristic;
develop at least one predictive model by using the geographic location profile; and
assess the at least one predictive model to determine whether at least one rate is within a predetermined range.

11. The computing device of claim 10, wherein the processor is further configured to:
determine, by using the at least one predictive model, at least one client intent for each of the at least one client, the at least one client intent relating to a predicted operating strategy; and
assign, by using the at least one predictive model, a confidence score for each of the at least one client intent.

12. The computing device of claim 10, wherein prior to generating the at least one advertisement campaign, the processor is further configured to:
aggregate raw data from at least one source, the raw data including identity information for the at least one client; and
generate the identity graph for each of the at least one client based on the raw data.

13. The computing device of claim 12, wherein the identity information includes at least one from among a name, an email address, a phone number, and a device identifier that is associated with the at least one client.

14. The computing device of claim 10, wherein the processor is further configured to:
aggregate outcome data that corresponds to each of the at least one client; and
train the at least one predictive model by using the outcome data.

15. The computing device of claim 14, wherein the outcome data relates to historical business activity data that corresponds to each of the at least one client, the historical business activity data including at least one from among merger data, acquisition data, and branch location data.

16. The computing device of claim 10, wherein the at least one client relates to an advertising target that corresponds to at least one from among an existing client and a potential client, the at least one client including at least one decision maker that is associated with an external entity.

17. The computing device of claim 10, wherein the processor is further configured to dynamically update the geographic location profile for each of the at least one client with new location data, the new location data resulting from subsequent renders of the at least one advertisement campaign.

18. The computing device of claim 10, wherein the at least one predictive model includes at least one from among a machine learning model, a mathematical model, a process model, and a data model.

19. A non-transitory computer readable storage medium storing instructions for facilitating predictive analytics based on geographic information from targeted advertising, the storage medium comprising executable code which, when executed by a processor, causes the processor to:
generate at least one advertisement campaign for at least one client based on a corresponding identity graph;
associate at least one tag with the generated at least one advertisement campaign, the at least one tag corresponding to instructions to collect location data when the at least one advertisement campaign is rendered on a client device;
distribute, by using the identity graph, the at least one advertisement campaign together with the at least one tag to the corresponding at least one client;
receive the location data for each of the at least one client when the at least one advertisement campaign is rendered;
determine a geographic location profile for each of the at least one client based on the received location data by further causing the processor to:
determine a location characteristic for each of the at least one client based on a geographic proximity between the corresponding at least one client and at least one other client,
wherein the location characteristic indicates a mutual connection between the corresponding at least one client and the at least one other client;
wherein the location characteristic for each of the at least one client is numerically represented in quantified form;
wherein the location characteristic for each of the at least one client is recorded in the quantified form; and
wherein the geographic location profile includes the location characteristic;
develop at least one predictive model by using the geographic location profile; and
assess the at least one predictive model to determine whether at least one rate is within a predetermined range.

20. The storage medium of claim 19, wherein the executable code, when executed by the processor, further causes the processor to:
determine, by using the at least one predictive model, at least one client intent for each of the at least one client, the at least one client intent relating to a predicted operating strategy; and
assign, by using the at least one predictive model, a confidence score for each of the at least one client intent.
